(19) United States
(12) Patent Application Publication
(10) Pub. No.: US 2007/0035455 A1
(43) Pub. Date: Feb. 15, 2007

(54) DISPLAY FRAME HAVING ANTENNA

(76) Inventor: Liang-Chih Tseng, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/307,164

(22) Filed: Jan. 26, 2006

(30) Foreign Application Priority Data
Aug. 10, 2005 (TW) 94213642

(51) Int. Cl. H01Q 1/24

(52) U.S. Cl. 343/702

(57) ABSTRACT

A display frame having an antenna suitable to be set on a display module is provided. The display frame includes a metal frame and an antenna, and the antenna includes a first metal member and a second metal member. The first metal member extending from the metal frame is located inside an antenna area defined by a notch of the metal frame. The second metal member extending from the metal frame is located inside the antenna area to couple the electromagnetic energy to the first metal member.

### CROSS-REFERENCE TO RELATED APPLICATION

This application claims the priority benefit of Taiwan application serial no. 94213642, filed on Aug. 10, 2005. All disclosure of the Taiwan application is incorporated herein by reference.

### BACKGROUND OF THE INVENTION

1. Field of the Invention

The present invention relates to a display frame, and more particularly, to a display frame having an antenna.

2. Description of the Related Art

With the continuous improvement of technology, notebooks (the laptop computers) are widely used and have become indispensable devices in our daily life. Therefore, the functionality and convenience of the notebook usually determine the efficiency of work or the entertainment effect. In addition, as the wireless network era arrives, an antenna is commonly configured in the notebook for supporting the wireless transmission. To meet the requirements of a compact notebook, the configuration of the antenna had become a very important topic.

In the conventional technology, for the notebook supports the wireless transmission, an external antenna is directly installed on the top side of the display in the notebook. However, as the external antenna is usually expensive, the cost of the notebook supporting wireless transmission function can be increased. In addition, since the external antenna is installed on the top side of the display, there is no additional protection element except for the cover of the external antenna. Accordingly, after a certain period of usage, the external antenna may be damaged due to improper operation, and the notebook may lose the wireless data transmission function.

In order to avoid the high cost of the external antenna and the inadequate protection on the external antenna, another notebook having an embedded antenna had been disclosed. FIG. 1 is a schematic 3D diagram of a conventional notebook. Referring to FIG. 1, the conventional notebook 100 comprises a host 110 and a display 120. In FIG. 1, only some components are exposed by removing the top cover of the display 120. The display 120 comprises a metal frame 122 and an antenna 124. The metal frame 122 supports the display 120, and the antenna 124 extends from the outer edge of the metal frame 122 for transmitting and receiving the wireless signal. However, for the notebook to be compact, the size of the display 120 should be reduced, such that a space 126 between the metal frame 122 and the display 120 should be decreased. However, the space 126 is usually for accommodating the wires or the digital camera. When the space 126 is decreased, the components (including the antenna 124) located inside the space are more congested, or some components even need to be removed.

### SUMMARY OF THE INVENTION

Therefore, an object of the present invention is to provide a display frame having an antenna with lower manufacturing cost and better spatial utilization.

In order to achieve the object mentioned above and others, the present invention provides a display frame having an antenna, and the display frame is suitable to be set on a display module. The display frame comprises a metal frame and an antenna, and the antenna comprises a first metal member and a second metal member. The first metal member extending from the metal frame is located inside an antenna area defined by a notch of the metal frame. The second metal member extending from the metal frame is located inside the antenna area in order to couple the electromagnetic energy to the first metal member.

In an embodiment of the present invention, the first metal member is formed by a part of the metal frame.

In an embodiment of the present invention, the second metal member is formed by a part of the metal frame.

In an embodiment of the present invention, the first metal member and the second metal member may be formed as an L shape.

In an embodiment of the present invention, the first metal member and the second metal member may be formed as a T shape.

In an embodiment of the present invention, an edge of the second metal member aligns with a profile of the metal frame, and the other edge of the second metal member aligns with an edge of the first metal member.

In an embodiment of the present invention, there is a feeding point on an intersection of the first metal member and the metal frame.

In summary, in the display frame having an antenna of the present invention, the first metal member and the second metal member of the antenna are formed by a part of the metal frame, and the first metal member and the second metal member are located in a specific antenna area. Accordingly, the manufacturing cost of the display frame having the antenna is decreased and the spatial utilization is improved.

### BRIEF DESCRIPTION DRAWINGS

The accompanying drawings are included to provide a further understanding of the invention, and are incorporated in and constitute a part of this specification. The drawings illustrate embodiments of the invention, and together with the description, serve to explain the principles of the invention.

FIG. 1 is a schematic 3D diagram of a conventional notebook.

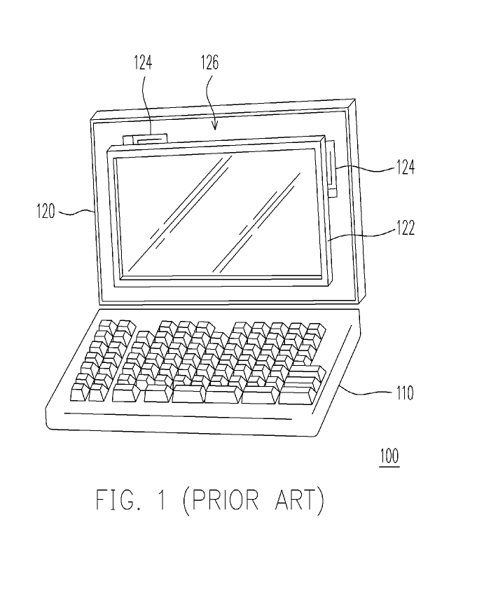

FIG. 2 is a schematic 3D diagram of a display frame according to an embodiment of the present invention.

FIG. 3 is a partial top view of the display frame of FIG. 2.

FIG. 4 is a partial top view of a display frame according to another embodiment of the present invention.

### DESCRIPTION OF PREFERRED EMBODIMENTS

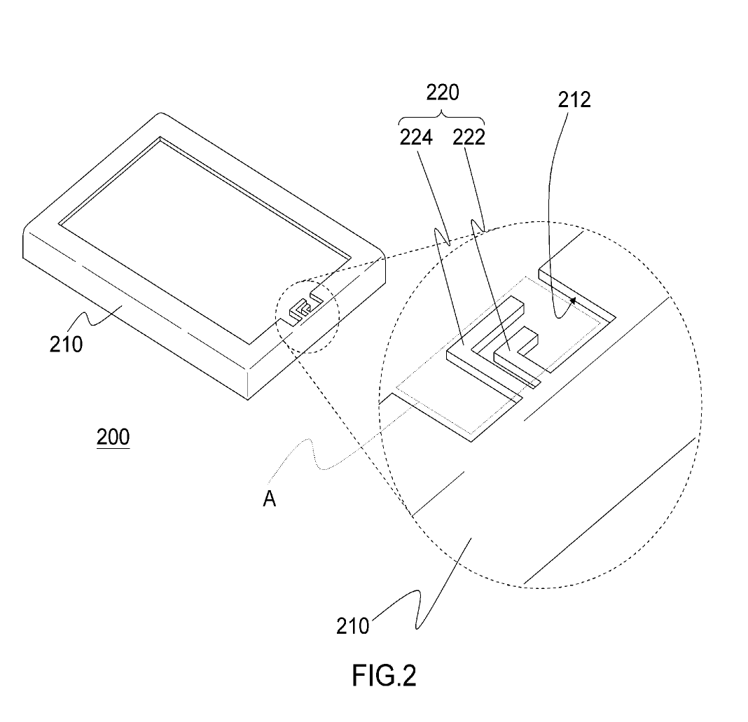

FIG. 2 is a schematic 3D diagram of a display frame according to an embodiment of the present invention. Referring to FIG. 2, the display frame 200 of the present invention comprises a metal frame 210 and an antenna 220. The antenna 220 comprises a first metal member 222 and a second metal member 224. The metal frame 210 has a notch 212 to define an antenna area A. Both of the first metal member 222 and the second metal member 224 extend from the metal frame 210 and are located inside the antenna area A. In addition, the second metal member 224 couples the electromagnetic energy to the first metal member 222, such that the antenna 220 can transmit or receive the wireless signal.

In the present embodiment, the first metal member 222 and the second metal member 224 are formed by a part of the metal frame 210, such that a predetermined area, i.e. the antenna area A, is defined inside the metal frame 210. Then, a structure of the antenna 220 is formed from a part of the metal frame 210 located in the antenna area A, thus the antenna 220 is formed and embedded in the metal frame 210. In the fabricating method mentioned above, since the antenna 220 is formed by a part of the metal frame 210, the material is saved and the manufacturing cost of the display frame 200 is decreased. However, the first metal member 222 and the second metal member 224 may not be formed by a part of the metal frame 210. Instead, the first metal member 222 and the second metal member 224 may be manufactured independently, and connected to an edge of the notch 210 in the metal frame 210. Note that the present invention does not limit the way of forming the first metal member 222 and the second metal member 224 on the metal frame 210. Also, since the display frame 200 uses a portion of the extension of the metal frame 210 as an area for embedding the antenna 220, the display frame 200 does not need additional outer space to locate the antenna 220. Accordingly, the spatial utilization of the display frame 200 is effectively improved when installed on a display module (not shown).

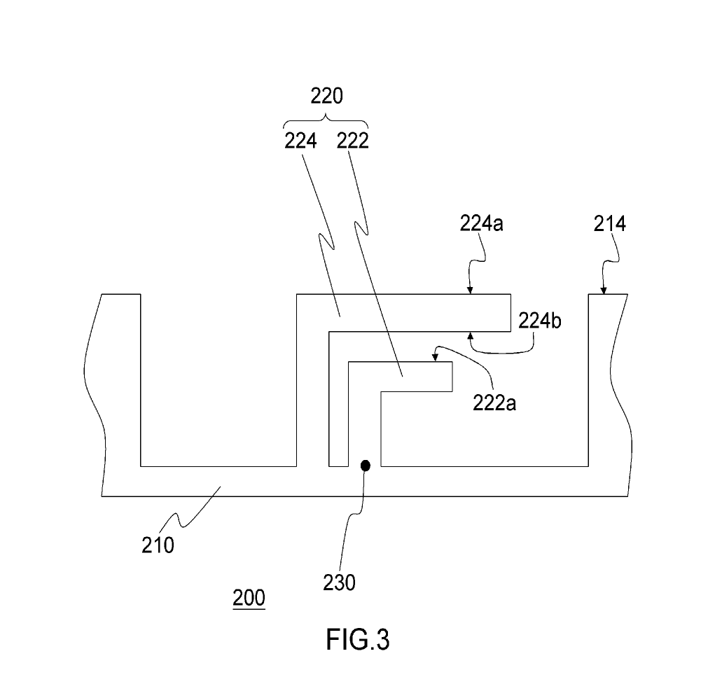

FIG. 3 is a partial top view of the display frame of FIG. 2. Referring to FIG. 3, the first metal member 222 and the second metal member 224 are formed as an L shape. In addition, an edge 224a of the second metal member 224 aligns with a profile 214 of the metal frame 210, and another edge 224b of the second metal member 224 also aligns with an edge 222a of the first metal member 222. The display frame 200 may comprise a feeding point 230, which is located on an intersection of the first metal member 222 and the metal frame 210. Here, the feeding point 230 is a terminal where the signal is fed into the antenna 220. With the first metal member 222, the electromagnetic energy is coupled to the second metal member 224, such that the antenna can transmit or receive the wireless signal.

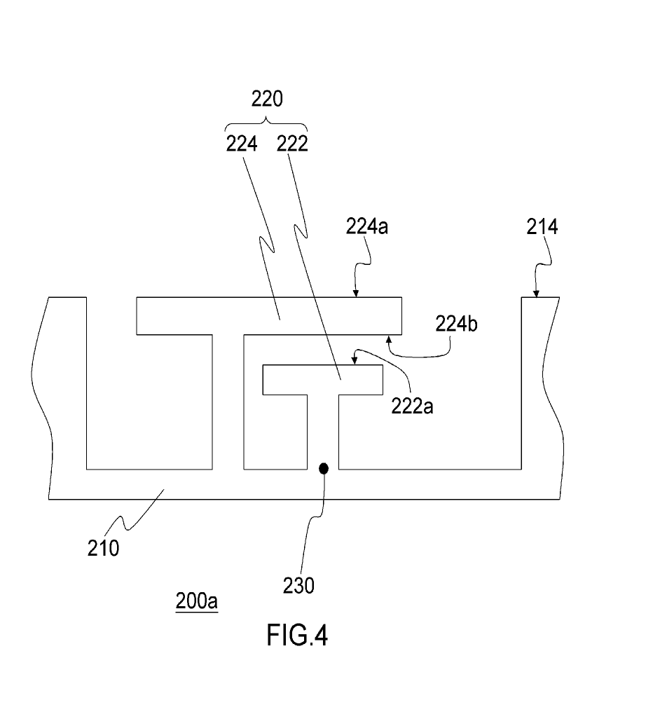

FIG. 4 is a partial top view of a display frame according to another embodiment of the present invention. For a simple explanation, the same members in FIG. 4 and 3 are marked with the same reference number, and detail are not repeated herein. Referring to FIG. 4, the display frame 200a of the present invention comprises a metal frame 210 and an antenna 220. The antenna 200 comprises a first metal member 222 and a second metal member 224. The first metal member 222 and the second metal member 224 formed as a T shape have a larger contact area, such that a better RF (Radio Frequency) performance is obtained, and the transmission quality of the antenna 220 is improved.

Referring to FIG. 3 and 4, the first metal member 222 and the second metal member 224 are formed as an L shape or a T shape. However, the shape of the first metal member 222 and the second metal member 224 as well as the layout of the edge positions are designed to achieve better communication quality. Accordingly, the present invention does not limit the shape of the first metal member 222 and the second metal member 224 and the layout of the edge positions.

In summary, in the display frame having an antenna of the present invention, since the first metal member and the second metal member are located inside the antenna area formed by the notch of the metal frame, and could be formed by a part of the metal frame, the spatial utilization of the display frame is increased and the manufacturing cost is decreased.

Although the invention has been described with reference to a particular embodiment thereof, it will be apparent to one of the ordinary skills in the art that modifications to the described embodiment may be made without departing from the spirit of the invention. Accordingly, the scope of the invention will be defined by the attached claims not by the above detailed description.

What is claimed is:

1. A display frame having an antenna, suitable to be set on a display module, the display frame comprising:
a metal frame; and
an antenna, comprising:
a first metal member, extending from the metal frame and located inside an antenna area defined by a notch of the metal frame; and
a second metal member, extending from the metal frame and located inside the antenna area to couple an electromagnetic energy to the first metal member.

2. The display frame having the antenna of claim 1, wherein the first metal member is formed by a part of the metal frame.

3. The display frame having the antenna of claim 1, wherein the second metal member is formed by a part of the metal frame.

4. The display frame having the antenna of claim 1, wherein the first metal member is formed as an L shape.

5. The display frame having the antenna of claim 4, wherein the second metal member is formed as an L shape.

6. The display frame having the antenna of claim 1, wherein the first metal member is formed as a T shape.

7. The display frame having the antenna of claim 6, wherein the second metal member is formed as a T shape.

8. The display frame having the antenna of claim 1, wherein an edge of the second metal member aligns with a profile of the metal frame.

9. The display frame having the antenna of claim 8, wherein another edge of the second metal member aligns with an edge of the first metal member.

10. The display frame having the antenna of claim 1, wherein there is a feeding point on an intersection of the first metal member and the metal frame.
